(19) United States
(12) Patent Application Publication
(10) Pub. No.: US 2012/0022916 A1
(43) Pub. Date: Jan. 26, 2012

(54) DIGITAL ANALYTICS PLATFORM

(75) Inventors: Greg Todd, Ormond Beach, FL (US); Ajay Easo, Chicago, IL (US); Lisa Suzanne Wilson, Chicago, IL (US)

(73) Assignee: Accenture Global Services Limited, Dublin (IE)

(21) Appl. No.: 13/186,878

(22) Filed: Jul. 20, 2011

Related U.S. Application Data
(60) Provisional application No. 61/365,928, filed on Jul. 20, 2010.

(51) Int. Cl. G06Q 10/00

(52) U.S. Cl. 705/7.31

(57) ABSTRACT

A digital analytics system includes a client profile database operable to store client profile data for clients. A client identification unit identifies the client profile data corresponding to a first client of the clients. An analytics engine is operable to identify descriptive and predictive analytic solutions corresponding to the client profile data of the first client, and receive a selection of one or more of the identified descriptive and predictive analytic solutions selected by the first client. The analytics engine is further operable to perform the descriptive and predictive analytic solutions selected by the first client and simultaneously perform one or more descriptive and predictive analytics solutions selected by a second client of the clients.

### PRIORITY

This application claims priority to U.S. Provisional Patent Application Ser. No. 61/365,928, filed Jul. 20, 2010, entitled “Digital Analytics Platform”, which is incorporated by reference in its entirety.

### BACKGROUND

Many companies and other entities (generally companies) are reevaluating how they make crucial business decisions. In order to make the best possible business decisions, companies desire to have the best possible information available. However, the availability and volume of data may pose a great barrier to these companies. For example, a company may need a third party's proprietary data that may not be publicly available. In another case, the amount of data available may be so large that it is difficult for the company to determine which data is even relevant to the business decision. Furthermore, the company may not have the expertise to properly analyze the data. Moreover, the company may not know how to use the data to positively impact their business decisions.

### SUMMARY OF THE INVENTION

According to an embodiment, a digital analytics platform includes a client profile database, a client identification unit, and an analytics engine. The client profile database is configured to store client profile data. The client identification unit is configured to identify the client profile data corresponding to a first client currently logged into the digital analytics platform. The analytics engine is configured to present a selection of descriptive and predictive analytic solutions corresponding to the client profile data of the first client; receive a selection of one or more descriptive and predictive analytic solutions selected by the first client; and perform the one or more descriptive and predictive analytic solutions selected by the first client. The digital analytic platform is configured to simultaneously perform one or more descriptive and predictive analytics solutions selected by a second client.

### BRIEF DESCRIPTION OF DRAWINGS

The embodiments of the invention will be described in detail in the following description with reference to the following figures.

FIG. 1 illustrates a system diagram for a digital analytics platform, according to an embodiment;

FIG. 2 illustrates a data flow diagram for a data integration unit, according to an embodiment;

FIG. 3 illustrates a system diagram for a data management system, according to an embodiment;

FIG. 4 illustrates a system diagram for an analytics engine, according to an embodiment;

FIG. 5 illustrates a method for providing descriptive and/or predictive analytic solutions, according to an embodiment;

FIG. 6 illustrates a method for identifying analytics based on client data, according to an embodiment;

FIG. 7 illustrates a model of client data, according to an embodiment; and

FIG. 8 illustrates a computer system, according to an embodiment.

### DETAILED DESCRIPTION OF EMBODIMENTS

For simplicity and illustrative purposes, the principles of the embodiments are described by referring mainly to examples thereof. Also, the embodiments may be used in combination with each other. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the embodiments. Also, the embodiments described herein may be used with each other in various combinations.

### 1. Overview

Analytics, or business data analysis, provide a company making a crucial business decision with an opportunity to achieve high performance by providing the best possible information relevant to the business decision to drive a high performance outcome. According to an embodiment, a digital analytics platform provides a variety of descriptive and/or predictive analytic solutions for multiple clients in a variety of industries. The digital analytics platform comprises hardware and software operable to provide the descriptive and/or predictive analytic solutions. A descriptive analytic solution may be alerts, queries, ad hoc reports, standard reports, etc. that provide data and insight into a current issue surrounding a crucial business decision. A predictive analytic solution may be optimization, predictive modeling, forecasting/extrapolation, statistical analysis, etc., that provide a possible resolution to the crucial business decision. A client is any company or other entity utilizing the digital analytics platform. The client may need to register with the digital analytics platform in order to utilize the digital analytics platform.

The digital analytics platform may provide descriptive and/or predictive analytic solutions that are industry-specific, client-specific and/or problem-specific. The digital analytics platform may operate as a service provider serving a variety of clients from a variety of industries. For example, the digital analytics platform may serve clients from the defense industry, the pharmaceutical industry, the construction industry, the banking industry, etc. Moreover, for each client, the digital analytics platform provides a variety of descriptive and/or predictive analytic solutions to a variety of problems that may be encountered by the client within a specific industry. For example, in the defense industry, a client may face the problem of how to detect possible threats. These threats may be internal threats such as an employee downloading sensitive data. The digital analytics platform may run predictive models that scan through the log data. Based upon a set of patterns and linear regression, possible threats are detected and alerts may be sent to security personnel. Furthermore, the digital analytics platform may also provide the variety of descriptive and/or predictive analytic solutions to a multitude of clients serving various industries simultaneously.

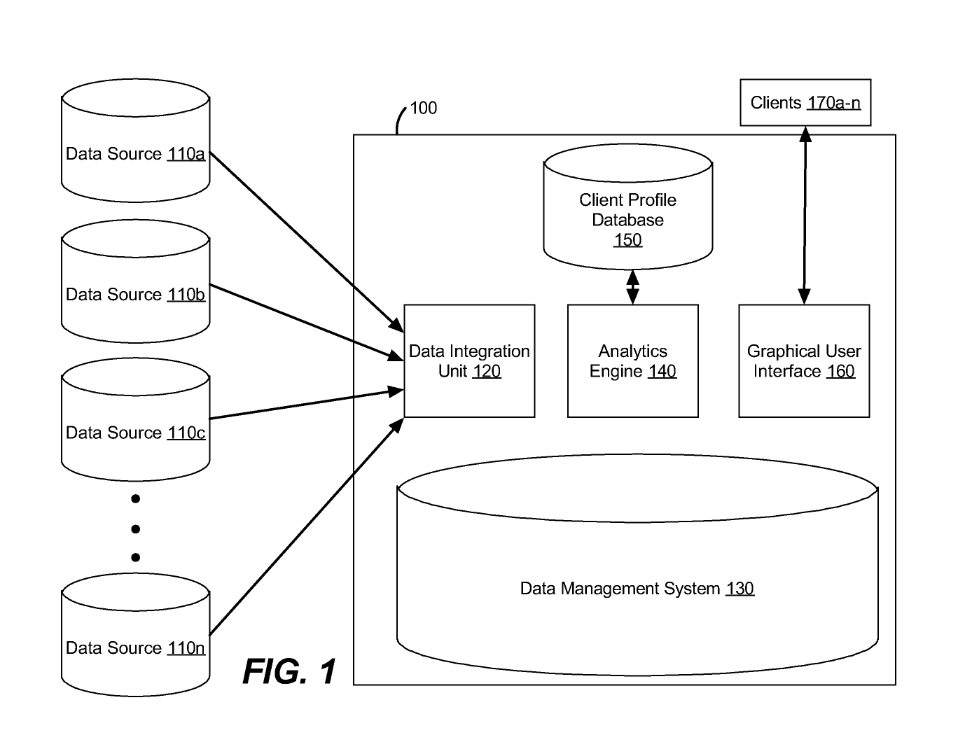

FIG. 1 illustrates a digital analytics platform 100, according to an embodiment of the invention. The digital analytics platform 100 provides descriptive and/or predictive analytic solutions for a multitude of clients 170a-n. The descriptive and/or predictive analytic solution provided to each of the clients 170a-n may be industry-specific and/or problem-specific.

The digital analytics platform 100 includes data integration unit 120, data management system 130, analytics engine 140, client profile database 150 and graphical user interface 160. A unit is a component of the system. The unit may be referred to as a module. The unit may be software, computer hardware, or a combination of both.

Data sources 110a-n may include a variety of different sources providing data to the digital analytics platform 100. The data sources 110a-n may include one or more of the clients 170a-n, third parties, and a service provider who is providing the digital analytics platform 100. The data sources 110a-n may provide data to the digital analytics platform 100 through real-time and/or batch processing, depending upon the data source, as further described below.

The data provided by the data sources 110a-n to the digital analytics platform 100 may include any data used to provide descriptive and/or predictive analytic solutions to the clients 170a-n. The data may include publicly available data. For example, the publicly available data stored in the data sources 110a-n may include market data, news, financials, industry specific data, regulatory changes, weather implications, trends, etc. The data provided by the data sources 110a-n may also include privately managed data. For example, the privately managed data may include client business process data, customer data, supply chain operations data, enterprise resource planning (ERP) transactions, workforce data, product/service development data, financial data, service provide research data, industry data, etc. The data provided by the data sources 110a-n may also include emerging data. Examples of the emerging data include regional data, eco-political updates, trade/tariff changes, competitor implications, value chain insight (i.e. customer and vendor data), innovation data, pipeline future value data, product development effectiveness data, competitors' innovation progress data, social network outlets, buzz on reputation/brand, etc. Other types of data may also be provided.

The data provided by the data sources 110a-n may be structured or unstructured data. Unstructured data is computerized information that does not have a data model or is not usable by a computer program in its current format. For example, the unstructured data may include data from social networks and news blogs, web data, etc. Structured data, on the other hand, either has a data model (e.g., adheres to a particular schema) or is usable by a computer program in its current format. For example, consumer profiles, consumer addresses, and revenue information may be provided by the data sources 110a-n in a predetermined format. The data integration unit 120 receives the data from the data sources 110a-n and loads the data into the data management system 130, as further explained below. The data management system 130 also creates several organizational units from the data. The analytics engine 140 creates models and provides the descriptive and/or predictive analytic solutions to the clients 170a-n. The client profile database 150 stores data provided by the clients 170a-n. The descriptive and/or predictive analytic solutions and other information may be displayed via descriptive reporting mechanisms such as secured web sites, dashboards, reports, mobile devices, and the graphical user interface 160. The details of the processing performed by the data integration unit 120, the data management system 130, the analytics engine 140, and the client profile database 150 are described in further detail below.

The digital analytics platform 100 may be implemented in a distributed computing environment, such as a cloud computing system. Clients 170a-n may interact with the digital analytics platform 100 through a network, such as the Internet. Also, the services provided by the digital analytics platform 100 may be subscription-based. For example, clients may contract with the digital analytics platform 100 service provider to receive one or more analytics on a subscription basis.

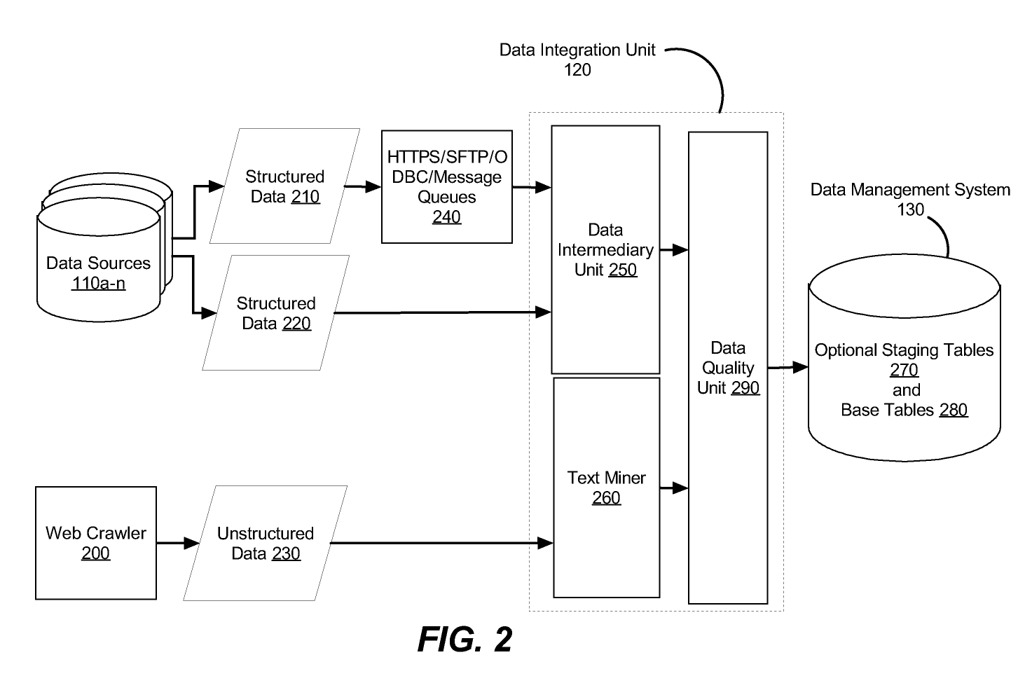

As discussed above, the data sources 110a-n may provide data to the digital analytics platform 100 through real-time and/or batch processing, depending upon the data source 110a-n. FIG. 2 is a data flow diagram showing the data flow from the data sources 110a-n to the data management system 130. FIG. 2 includes the data sources 110a-n, web crawler 200, structured data 210 and 220, unstructured data 230, HTTPS/SFTP/ODBC/Message Queues 240, data intermediary unit 250, text miner 260, optional staging tables 270, base tables 280 and data quality unit 290.

The data sources 110a-n may “push” data out to the data integration unit 120 or the data may be “pulled” into the data integration unit 120. The unstructured data 230 may be captured through the use of the web crawler 200. A web crawler is a computer program that browses the World Wide Web in a methodical and automated manner. In FIG. 2, the web crawler 200 browses the web for data related to the industries that the digital analytics platform 100 serves. The unstructured data 230 captured by the web crawler 200 is fed to the text miner 260. Text mining, or text data mining, may include deriving high quality information from text. Thus, via the text miner 260, the digital analytics platform 100 receives high quality relevant data derived from the unstructured data 230, such as news blogs and social networks.

The structured data 210 may be updated through batch processing. Batch processing is an efficient way of processing a high volume of data. During batch processing, transactions collected over a period of time are processed and the batch results are produced. The structured data 210 from the data sources 110a-n is periodically collected and may be pushed or pulled via HTTPS/SFTP/ODBC/Message Queues 240. The data intermediary unit 250 pulls the structured data 210 from the HTTPS/SFTP/ODBC/Message Queues 240 periodically.

The structured data 220 is updated through real-time processing. During real-time processing, there is a continuous processing of the structured data 220. The structured data 220 is processed over a very short time period, i.e. real-time. The structured data 220 from the data sources 110a-n is then fed to the data intermediary unit 250.

Once the data intermediary unit 250 collects the structured data 210 and 220 and the text miner 260 collects the unstructured data 230, the structured data 210 and 220 and the unstructured data 230 is cleansed and checked for completeness by the data quality unit 290 using known techniques, before the structured data 210 and 220 and the unstructured data 230 is loaded into the optional staging tables 270, if necessary, and then the base tables 280. A staging table may be an intermediate table used for data manipulation. More specifically, the data quality unit 290 checks the structured data 210 and 220 and the unstructured data 230 for completeness and stage correctness. Referential integrity checks are also performed. Integrity checks may include comparing the received data to data ranges or to a baseline to determine whether the data is accurate. The data is then loaded into the optional staging tables 270, if necessary, and then the base tables 280 of the data management system 130.

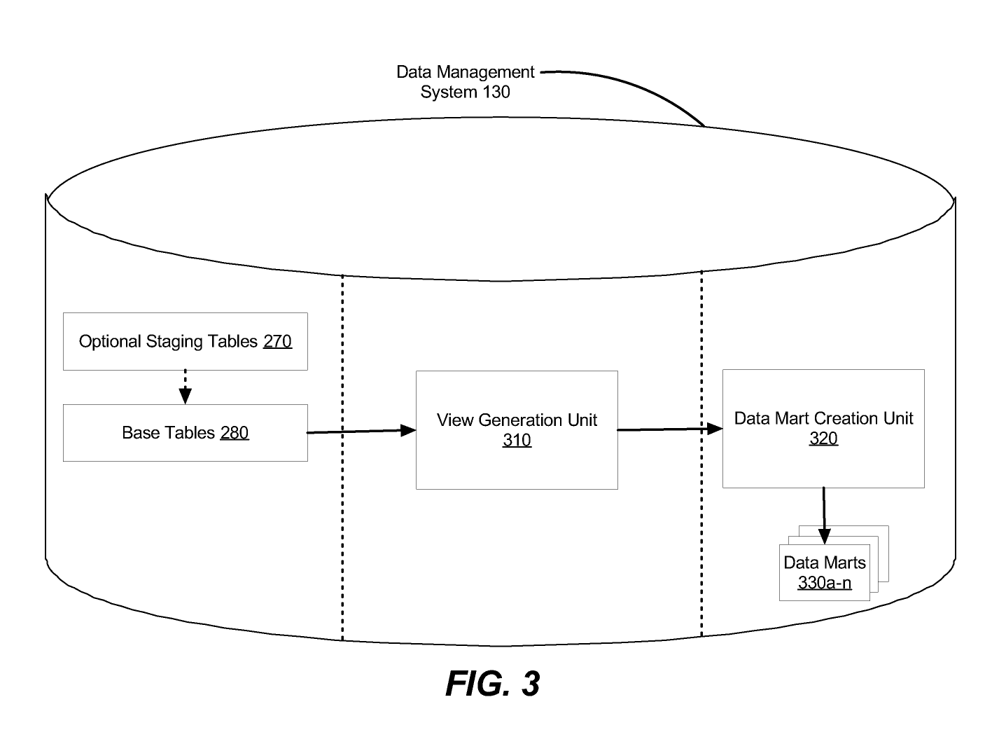

FIG. 3 illustrates the data management system 130. The data management system 130 includes the optional staging tables 270 and the base tables 280, view generation unit 310, data mart creation unit 320 and data marts 330a-n. As discussed above, the data is loaded into the optional staging tables 270, if necessary, and the base tables 280. The view generation unit 310 generates views of the data. A view is an object similar to a table. Views are created to provide a customized version of one or more tables. However, no data is actually stored in the view. Instead, what is stored in the view is a set of query commands that retrieve the data that make up the view.

The data mart creation unit 320 then creates the data marts 330a-n. A data mart is a data repository that may contain a subset of data, usually oriented to a specific purpose or data subject, that may be distributed to support business needs. A data mart enables reporting and queries to be performed on the data residing in the data mart. The data marts 330a-n are created by the data mart creation unit 320 to provide ease of access to the data stored in the base tables 280 that will be used in the descriptive and/or predictive analytic solutions provided by the digital analytics platform 100. For example, the data marts 330a-n may contain data organized by industry for industry-specific analytic solutions. Other data repositories such as relational databases or an OLAP system may also be used.

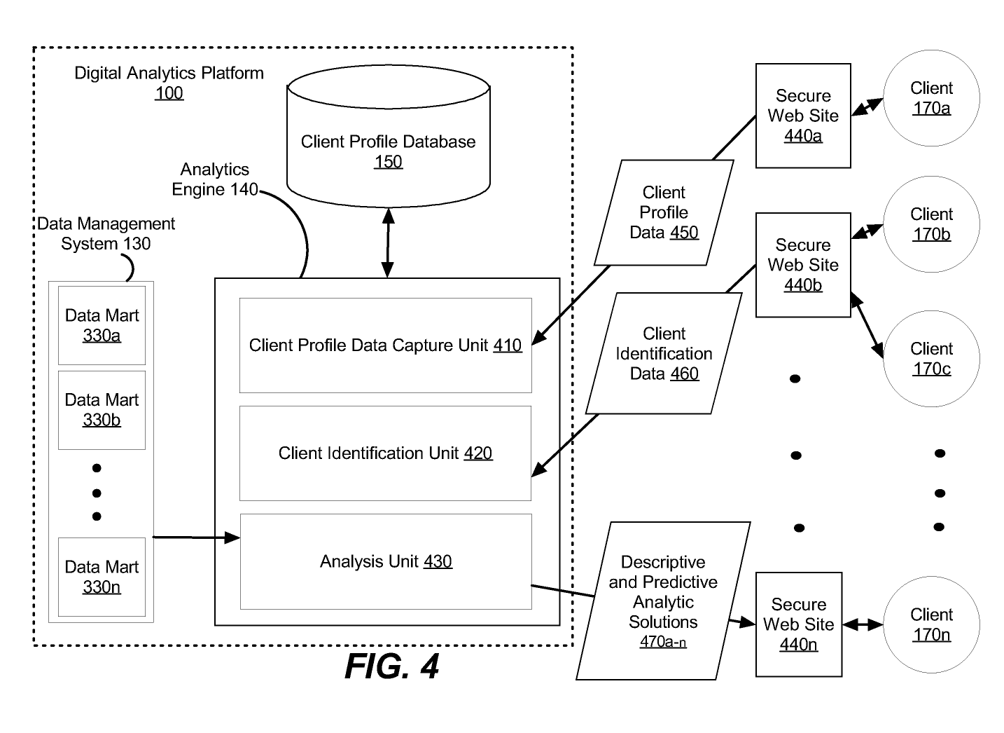

FIG. 4 illustrates the analytics engine 140. The analytics engine 140 includes client profile data capture unit 410, client identification unit 420 and analysis unit 430.

The analytics engine 140 creates models based on the data retrieved from the data marts 330a-n by the analysis unit 430. The analytics engine 140 provides one or more descriptive and/or predictive analytic solutions 470a-n based on the models created by the analysis unit 430. The descriptive analytic solutions may include alerts, queries, ad hoc reports, standard reports, etc. created by the analytics engine 140. The predictive analytic solutions may include segmentation, statistical analysis, forecasting/extrapolation, predictive modeling, optimization, text mining, etc. created by the analytics engine 140.

As discussed above, the analytics engine 140 provides the descriptive and/or predictive analytic solutions 470a-n to the clients 170a-n shown in FIG. 1. To become a client, an entity or company (generally company) may have to register for the services provided by the digital analytics platform 100. The company may register with the digital analytics platform 100 for the services and receive the descriptive and/or predictive analytic solutions 470a-n via secured web sites 440a-n. The descriptive and/or predictive analytic solutions 470a-n may also be received via mobile devices, email, etc. The secured web sites 440a-n may interface with the graphical user interface 160 of the digital analytics platform 100.

When the company accesses one of the secure web sites 440a-n, such as the secured web site 440a, the secured web site 440a prompts the company to log into the secured web site 440a via a secure LDAP process to obtain the descriptive and/or predictive analytic solutions 470a-n or to register with the client profile data capture unit 410. If the company does not log into the secured web site 440a and instead chooses to register with the client profile data capture unit 410, the company provides client profile data to the client profile data capture unit 410 via a registration form. The client profile data 450 may include a login ID and password, an industry the company serves, a selection of descriptive and/or predictive analytic solutions the company is interested in, etc. Once the client profile data 450 is entered in the registration form, submitted by the company and captured by the client profile data capture unit 410, the company is registered as one of the clients 170a-n. As shown in FIG. 4, the client profile data 450 is submitted from the secured web site 440a, but the client profile data 450 may be submitted from any one of the secured web sites 440a-n. The client profile data 450 captured by the client profile data capture unit 410 is then stored in the client profile database 150.

The company, now registered, may log into one of the secured web sites 440a-n as one of the clients 170a-n, such as client 170a, and utilize the digital analytics platform 100. For example, once the client 170a logs into the digital analytics platform 100, the client identification unit 420 determines client identification data 460 which may include information that identifies or can be used to identify the client 170a. For example, the client 170a logs into one of the secured web sites, such as the secured web site 440b, and a login ID is captured when it is entered. As shown in FIG. 4, the client identification data 460 is submitted from the secured web site 440b to the client identification unit 420, but the client identification data 460 may be submitted from any one of the secured web sites 440a-n to the client identification unit 420. In another example, the client identification unit 420 may determine the client identification data 460 is an IP address of the registered client 170a from a data packet from the client 170a.

Once the client 170a is identified, the client identification unit 420 retrieves the client profile data 450 corresponding to the client 170a from the client profile database 150. Based on the client profile data 450, the client 170a is presented with a subset of the available descriptive and/or predictive analytic solutions 470a-n that are specific to the industry that is listed in the client profile data 450 for the client 170a. The client 170a may request one or more of the problem-specific descriptive and/or predictive analytic solutions 470a-n for immediate consumption on one of the secured web sites 440a-n. The client 170a may also request ongoing descriptive and/or predictive analytic solutions 470a-n be published on one of the secured web sites 440a-n at regular intervals. The client may also request other delivery methods including a PDA/email, a dashboard/portal, etc.

Once the client 170a selects one or more of the available descriptive and/or predictive analytic solutions 470a-n, the analysis unit 430 retrieves data from the data marts 330a-n corresponding to the selected descriptive and/or predictive analytic solutions, e.g. predictive analytic solution 470a, to perform the analytics required by the predictive analytic solution 470a. The analytics may include segmentation, statistical analysis, forecasting/extrapolation, predictive modeling, optimization and text mining. Segmentation is a method of optimizing performance by determining a specific audience for a business solution and customizing the business solution with the specific audience in mind. The descriptive and/or predictive analytic solutions may be customized for different audiences or populations. Statistical analysis includes summarizing and presenting data, estimation, confidence intervals, hypothesis testing, etc. Forecasting is the process of making statements about events whose actual outcomes have not yet been observed. Extrapolation is the process of constructing new data points outside of a discrete set of known data points. Predictive modeling is a process of creating or choosing a model to predict the probability of an outcome. Optimization is the improvement of a process, product, business solution, etc. Text mining is the process of deriving high-quality information from text.

The digital analytics platform 100 may provide the selected descriptive and/or predictive analytic solutions 470a-n generated by the analytics engine 140 to one of the secured web sites 440a-n for immediate consumption. As shown in FIG. 4, the selected descriptive and/or predictive analytic solutions 470a-n are sent to the secured web site 440c, but the selected descriptive and/or predictive analytic solutions 470a-n may be sent to any one of the secured web sites 440a-n. The secured web sites 440a-n may includes the graphical user interface 160 shown in FIG. 1. Ongoing descriptive and/or predictive analytic solutions 470a-n may be published on one of the secured web sites 440a-n at regular intervals. Other delivery methods may be chosen including a PDA/email, a dashboard/portal, etc.

According to an embodiment, the digital analytics platform 100 has a technical architecture comprised of layers of system software and extensions to system software. The technical architecture, for example, comprises a development environment, an execution environment and an operations environment. The execution environment supports applications, including analytics applications at run-time. It is comprised of a unified collection of run-time technology services, control structures, and supporting infrastructure upon which application software runs. The operations environment supports the ongoing support and maintenance of applications (and the other elements of the technical architecture). It is comprised of a unified collection of technology services, tools, standards, and control structures required to keep a business application production or development environment operating at the designed service level. This may include backup and recovery systems.

The development environment supports the development of applications (and the other elements of the technical architecture). It is comprised of technology services, tools, techniques, and standards for designing, building, and testing new application software and technical architecture components. The development environment is composed of the following environments: the proof of concept (POC) environment is an area meant for client teams for creation of proof of concepts to showcase to potential clients; the development environment is where applications are built; the test environment is used to verify the functionality correctness of applications design or model; and the pre-prod environment mirrors the production environment and is used to test and tune the application. Analytics applications may be developed in this environment.

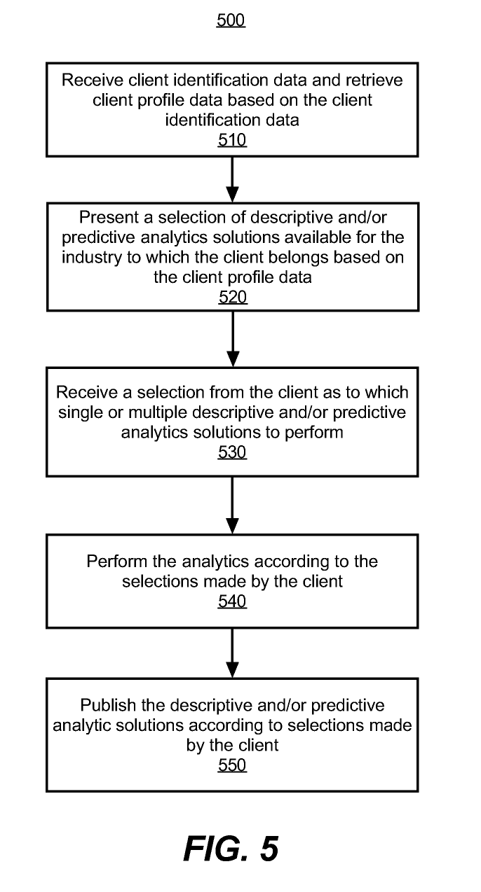

FIG. 5 shows a flowchart of a method 500 for providing descriptive and/or predictive analytic solutions, according to an embodiment. The method 500 may be implemented on the digital analytics platform 100 described above referring to FIGS. 1-4 by way of example and not limitation. The method 500 may be practiced in other systems.

At step 510, the digital analytics platform 100 receives client identification data and retrieves client profile data from a client profile database based on the client identification data. As discussed above, a registered client may log into a web site, portal, dashboard, etc. and utilize the digital analytics platform 100. Once the client logs in, the digital analytics platform 100 determines information that identifies or can be used to identify the client. Once the client is identified, the digital analytics platform 100 retrieves the client profile data corresponding to the client.

At step 520, the digital analytics platform 100 presents a variety of available descriptive and/or predictive analytic solutions to the client that are specific to the industry to which the client belongs based on the retrieved client profile data. A descriptive analytic solution may be alerts, queries, ad hoc reports, standard reports, etc. that provide data and insight into a current issue surrounding a crucial business decision. A predictive analytic solution may be optimization, predictive modeling, forecasting/extrapolation, statistical analysis, etc., that provide a possible resolution to the crucial business decision. An analytic solution may comprise an analytics application executed by the digital analytics platform 100 to perform analytics, which may be specific to the client or the client's industry. Analytics is the application of computer technology, operational research, and statistics to solve problems in business and industry. The analytic solutions may operate to obtain an optimal or realistic decision based on existing data. The analytics provided by the digital analytics platform 100 may include marketing analytics, business analytics, web analytics, etc.

At step 530, the digital analytics platform 100 receives a selection from the client as to which one or more descriptive and/or predictive analytic solutions to perform. The client may request the one or more descriptive and/or predictive analytic solutions for immediate consumption on the web site, dashboard, portal, etc. The client may also request ongoing results for one or more descriptive and/or predictive analytic solutions to be published on the web site, dashboard, portal, etc. at regular intervals. Of course, the descriptive and/or analytic solutions may also be published on a graphical user interface as well.

At step 540, the digital analytics platform 100 displays the descriptive and/or predictive analytic solutions according to the selections made by the client. Once the client selects one or more descriptive and/or predictive analytic solutions, the digital analytics platform 100 retrieves data from data marts corresponding to the selected analytic solutions and runs the selected analytic solutions. This may include running the analytics applications for the solutions to perform the desired analytics. The descriptive and/or predictive analytic solutions may be reported to the clients 170a-n. The digital analytics platform 100 may perform analytics simultaneously for multiple clients.

At step 550, the digital analytics platform 100 publishes the output of the selected descriptive and/or analytic solutions executed by the digital analytics platform 100. The digital analytics platform 100 may provide the output of the descriptive and/or predictive analytic solution to the secure website for immediate consumption. The digital analytics platform 100 may publish the descriptive and/or predictive analytic solutions on the web site at regular intervals. Of course, the results of the descriptive and/or predictive analytic solutions may be published on the web site, or may be published to the graphical user interface, to a PDA/email, to a dashboard/portal, etc. A multitude of instances of the method 500 can be performed simultaneously on the digital analytics platform 100.

As indicated above, the digital analytics platform 100 may be implemented in a distributed computing environment, such as a cloud computing system. The services provided by the digital analytics platform 100 may be subscription-based.

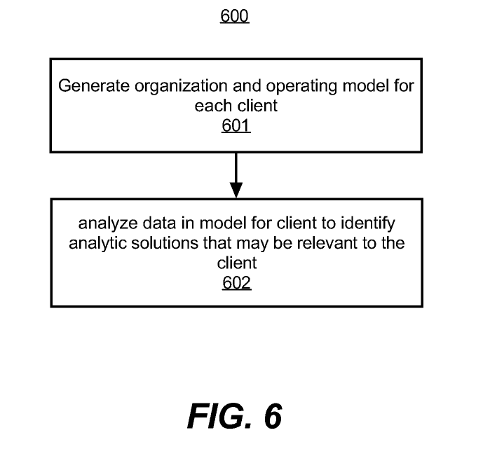

FIG. 6 illustrates a method 600 for determining recommendations of analytic solutions for a client, according to an embodiment. The steps of the method 600 may be performed as sub-steps for step 520 of the method 500 to determine and present a variety of available descriptive and/or predictive analytic solutions to the client. The method 600 may be performed by the digital analytics platform 100 or other systems.

At step 601, an organization and operating model is generated for the client. The model includes information pertaining to the client, including the client profile data. The information in the model may include the information needs of the client to support customers and to differentiate the client in the market place from its competitors.

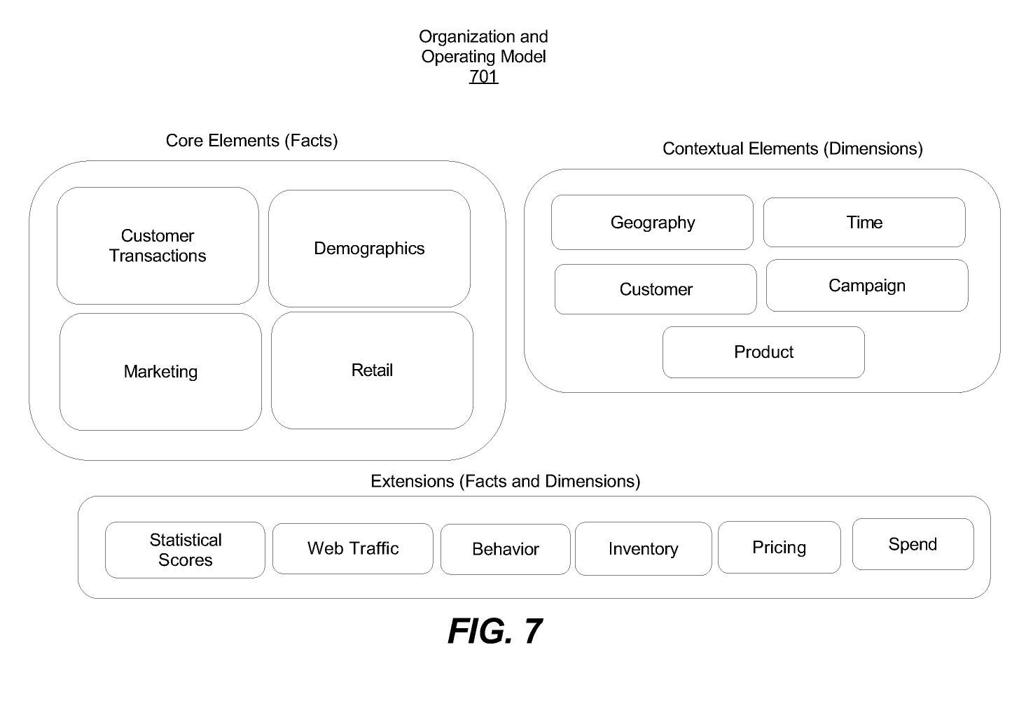

Examples of data that may be included in the organization and operating model 701 are shown in FIG. 7. The data may include core elements (facts) and contextual elements (dimensions) for the client. The core elements may include identifiable transactions, events and their attributes. The core elements may include marketing information for the client, client demographics and retail information. Marketing information may include information for ad campaigns, promotions, marketing budget, etc. Retail information may include information about stores, sales volume, customers, etc. The contextual elements may be used to organize data across different dimensions for viewing in reports. Examples of contextual elements may include geography, time, client customer, ad campaign and product. Additional data is shown under extensions for the core elements and contextual elements. Examples of the additional data may include statistical scores, web traffic, behavior, inventory, and pricing.

At step 602, the data in the model is analyzed to identify analytic solutions that may be relevant to the client. For example, sales, marketing, retail and inventory information in the model is analyzed to determine if it would be beneficial to run various marketing, business and inventory analytics for the client. Benchmarks may be used to determine if the analytics are needed. For example, sales performance may be compared to thresholds for the industry to determine if the client is above or below industry standards. Then, various analytics may be suggested to the client. Also, a roadmap may be generated for the client that recommends analytics based on the current metrics for the client and recommends analytics for the future, for example, as sales volume grows.

Also, analytics may be created for the client. For example, analytics may be designed, built and deployed in the digital analytics platform 100 that are applicable to the needs of the client. These newly developed analytics may be recommended to the client.

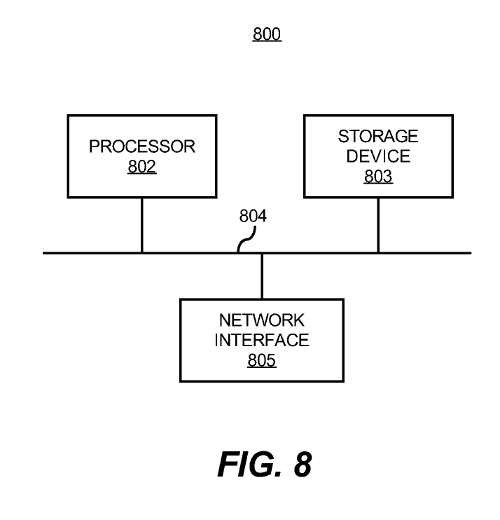

FIG. 8 shows a computer system 800 that may be used as a hardware platform for the digital analytics platform 100. The computer system 800 may be used as a platform for executing one or more of the steps, methods, and functions described herein that may be embodied as software stored on one or more computer readable storage devices, which are hardware storage devices. The computer system 800 may represent a server in a distributed computing environment.

The computer system 800 includes a processor 802 or processing circuitry that may implement or execute software instructions performing some or all of the methods, functions and other steps described herein. Commands and data from the processor 802 are communicated over a communication bus 804. The computer system 800 also includes a non-transitory computer readable storage device 803, such as random access memory (RAM), where the software and data for processor 802 may reside during runtime. The storage device 803 may also include non-volatile data storage. The computer system 800 may include a network interface 805 for connecting to a network. It will be apparent to one of ordinary skill in the art that other known electronic components may be added or substituted in the computer system 800.

While the embodiments have been described with reference to examples, those skilled in the art will be able to make various modifications to the described embodiments without departing from the scope of the claimed embodiments. Also, the embodiments are generally described with respect to providing analytics. However, the embodiments are also applicable to optimizations of analytics, providing industry-specific and client-specific news alerts, providing industry-specific scientific data, etc.

What is claimed is:

1. A digital analytics system comprising:
a client profile database to store client profile data for clients;
a client identification unit to identify the client profile data corresponding to a first client of the clients;
an analytics engine executed by a processor to:
identify descriptive and predictive analytic solutions corresponding to the client profile data of the first client;
receive a selection of one or more of the identified descriptive and predictive analytic solutions selected by the first client; and
perform the one or more descriptive and predictive analytic solutions selected by the first client and simultaneously perform one or more descriptive and predictive analytics solutions selected by a second client of the clients.

2. The digital analytics system of claim 1, wherein the selection of descriptive and predictive analytic solutions are specific to an industry specified in the client profile data of the first client.

3. The digital analytics system of claim 1, wherein the one or more descriptive and predictive analytic solutions selected by the second client are for an industry different from the industry in the client profile data of the first client.

4. The digital analytics system of claim 1, wherein the first and second clients are logged into the digital analytics system to select descriptive and predictive analytic solutions.

5. The digital analytics system of claim 1, wherein the analytics engine identifies the descriptive and predictive analytic solutions corresponding to the client profile data of the first client is based on comparison of industry benchmarks to metrics for the first client.

6. The digital analytics system of claim 1, comprising a data management system determining an organization and operating model for each client, the model including core elements and contextual elements describing each client's business, wherein the analytics engine identifies the descriptive and predictive analytic solutions for the first client based on the model for the first client.

7. The digital analytics system of claim 6, wherein the core elements comprise sales data, marketing information, and client demographics.

8. The digital analytics system of claim 1, comprising:
a data mart creation unit to create data marts from data received from a plurality of sources, wherein each data mart contains a subset of the data for a specific data subject.

9. The digital analytics system of claim 8, wherein the data in the data marts are used in the descriptive and predictive analytic solutions provided by the digital analytics system.

10. The digital analytics system of claim 1, wherein the system provides an analytic solutions development environment, an execution environment and an operations environment.

11. A method for identifying one or more descriptive and predictive analytic solutions operable to be performed by a digital analytics system, the method comprising:
storing client profile data for clients;
identifying the stored client profile data corresponding to a first client of the clients;
identifying, by a processor, descriptive and predictive analytic solutions corresponding to the client profile data of the first client;
receiving a selection of one or more of the identified descriptive and predictive analytic solutions selected by the first client; and
performing the one or more descriptive and predictive analytic solutions selected by the first client and simultaneously performing one or more descriptive and predictive analytics solutions selected by a second client of the clients.

12. The method of claim 11, wherein the selection of descriptive and predictive analytic solutions are specific to an industry specified in the client profile data of the first client, and the one or more descriptive and predictive analytic solutions selected by the second client are for an industry different from the industry in the client profile data of the first client.

13. The method of claim 11, comprising comparing industry benchmarks to metrics for the first client to identify the descriptive and predictive analytic solutions for the first client.

14. The method of claim 11, comprising determining an organization and operating model for each client, the model including core elements and contextual elements describing each client's business, wherein the descriptive and predictive analytic solutions for the first client are identified based on the model for the first client.

15. The method of claim 14, wherein the core elements comprise sales data, marketing information, and client demographics.

16. The method of claim 11, comprising creating data marts from data received from a plurality of sources, wherein each data mart contains a subset of the data for a specific data subject.

17. The method of claim 16, wherein the data in the data marts are used in the descriptive and predictive analytic solutions provided by the digital analytics system.

18. A non-transitory computer readable medium storing machine readable instructions that when executed by a processor perform a method for identifying one or more descriptive and predictive analytic solutions operable to be performed by a digital analytics system, the method comprising:
storing client profile data for clients;
identifying the stored client profile data corresponding to a first client of the clients;
identifying descriptive and predictive analytic solutions corresponding to the client profile data of the first client;
receiving a selection of one or more of the identified descriptive and predictive analytic solutions selected by the first client; and
performing the one or more descriptive and predictive analytic solutions selected by the first client and simultaneously performing one or more descriptive and predictive analytics solutions selected by a second client of the clients.

19. The non-transitory computer readable medium of claim 18, wherein the selection of descriptive and predictive analytic solutions are specific to an industry specified in the client profile data of the first client, and the one or more descriptive and predictive analytic solutions selected by the second client are for an industry different from the industry in the client profile data of the first client.

20. The non-transitory computer readable medium of claim 18, wherein the method comprises comparing industry benchmarks to metrics for the first client to identify the descriptive and predictive analytic solutions for the first client.
